(19) United States
(12) Patent Application Publication
(10) Pub. No.: US 2015/0042483 A1
(43) Pub. Date: Feb. 12, 2015

(54) Marine Safety Analysis Software Application

(71) Applicant: Ryan Joseph Hageman, Boca Raton, FL (US)

(72) Inventor: Ryan Joseph Hageman, Boca Raton, FL (US)

(21) Appl. No.: 13/964,149

(22) Filed: Aug. 12, 2013

(51) Int. Cl. G08B 23/00

(52) U.S. Cl. CPC G08B 23/00
USPC 340/691.6

(57) ABSTRACT

Currently, mariners do not have an accurate way to measure work safety when at sea. The Marine Safety Analysis Software Application is designed to improve safety and prevent accidents when used by mariners. The application analyzes motion data obtained via multiple sensors placed on the ship. These sensors gather metrics which are transmitted to the application. The application then compares the data to user inputs and based on predetermined metrics a “work safety category” is created. Depending on the “work safety category”, the user decides whether the task at hand should be started, continued, or stopped. This application may help prevent accidents by providing a clearer safety assessment to all those who work on the water.

### BACKGROUND OF THE INVENTION

The present invention relates to an analysis software and, more particularly, to an analysis software connected to multiple sensors on a boat.

When using a boat in a sea or ocean, currently the surrounding conditions are determined by humans before and during the performance of dangerous tasks. It is difficult to accurately determine whether deck, crane, helicopter, or over the side operations may be done in a safe manner on the boat. The determinations depend on people being able to decipher the conditions themselves regarding whether to start, continue, or stop operations.

As can be seen, there is a need for a system of determining conditions for boat operations.

### BRIEF DESCRIPTION OF THE DRAWINGS

FIG. 1: is a schematic diagram of the inputs.

FIG. 2: is a perspective view of a boat.

FIG. 3: is a schematic diagram of a typical display.

FIG. 4: is the Dialog Box for the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a system for alerting seaman of dangerous conditions, comprising: a computer having a user interface; and a program product comprising machine-readable program code for causing, when executed, the computer to perform the following process steps: receiving inputs from a plurality of sensors placed around a boat; comparing the inputs to a predetermined range of safe and dangerous conditions; and displaying a warning signal when the inputs fall within the predetermined dangerous conditions.

The present invention may include a software application that may alert a user when set limits are exceeded over a set time interval. To alert the user, a series of color categories may set off. The numerical valves may be averaged over a set period of time. This may include wind direction, wind speed, current speed, current direction, a vessel's heave, pitch, sway, yaw, surge, roll motions, a vessel's thrusters power load, generator power load and the like.

The present invention may provide the ability to have metrics integrated into a software application to give a category of overall safety. The categories may include, but is not limited to, Red (All Stop Work), Yellow (Consult with Master, OIM, Client Representative), and Green (Safe Work Conditions). This category could be seen in the bottom menu bar as a colored block or in a separate menu located Top Menu Bar.

The present invention may include at least one computer with a user interface. The computer includes a program product including a machine-readable program code for causing, when executed, the computer to perform steps. The program product may include software which may be loaded onto the hard drive of the computer or accessed by the computer. The computer may access the software via the web browser using the internet, extranet, intranet, host server, internet cloud and the like. Each software unit may have a unique Identification number associated with it.

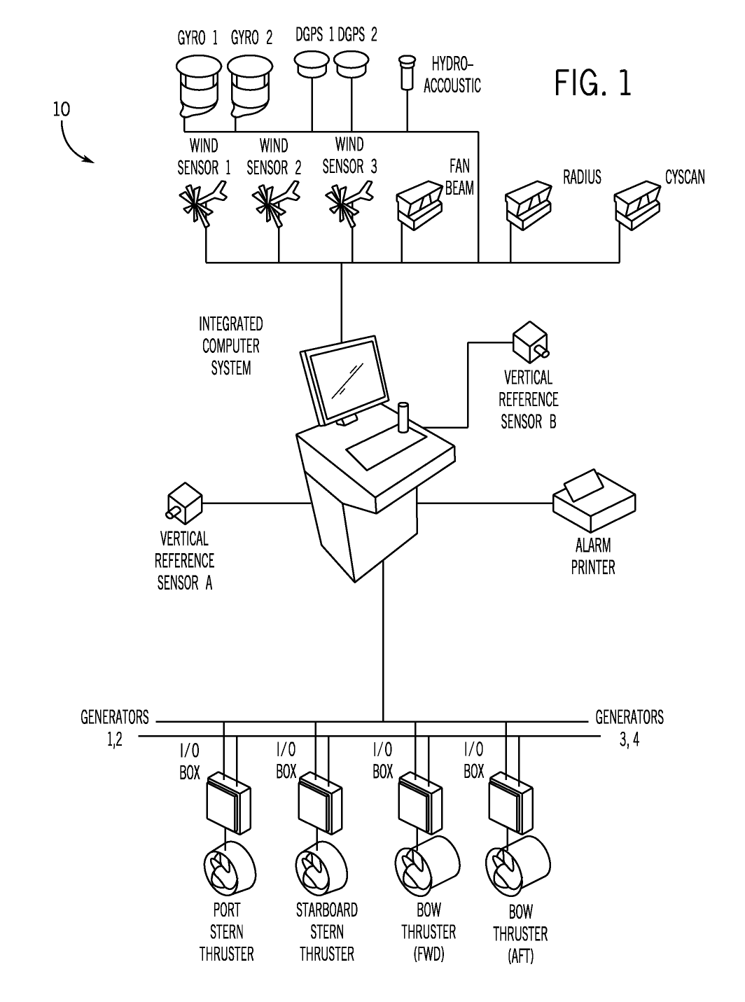

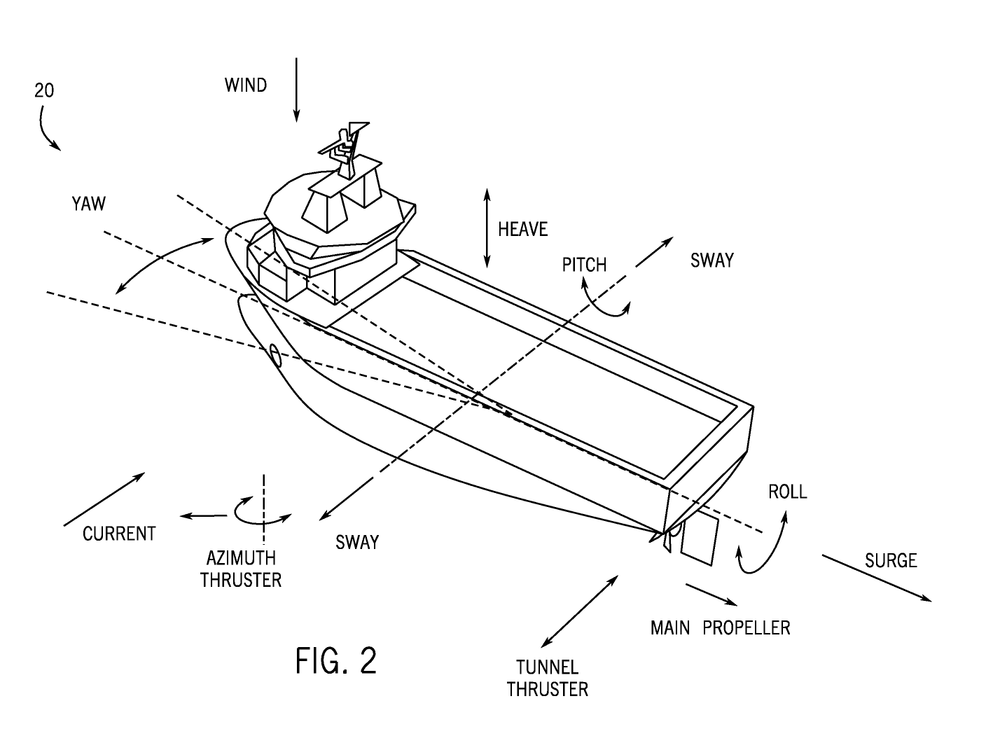

Referring now to FIGS. 1 through 4, the present invention may include multiple sensors 10. The sensors 10 may include but are not limited to, a gyro sensor, DGPS sensor, hydro-acoustic sensor, wind sensor, fan beam sensor, vertical reference sensor, radius sensor, cyscan sensor, bow thruster sensor, port stern thruster sensor, starboard stern thruster sensor, generator load sensor, and the like. Each sensor may be strategically placed around the boat 20 to sense elements that may cause potential danger. The sensors 10 may be operatively connected to a computer. The computer may read the data and compare the data to preset limitations.

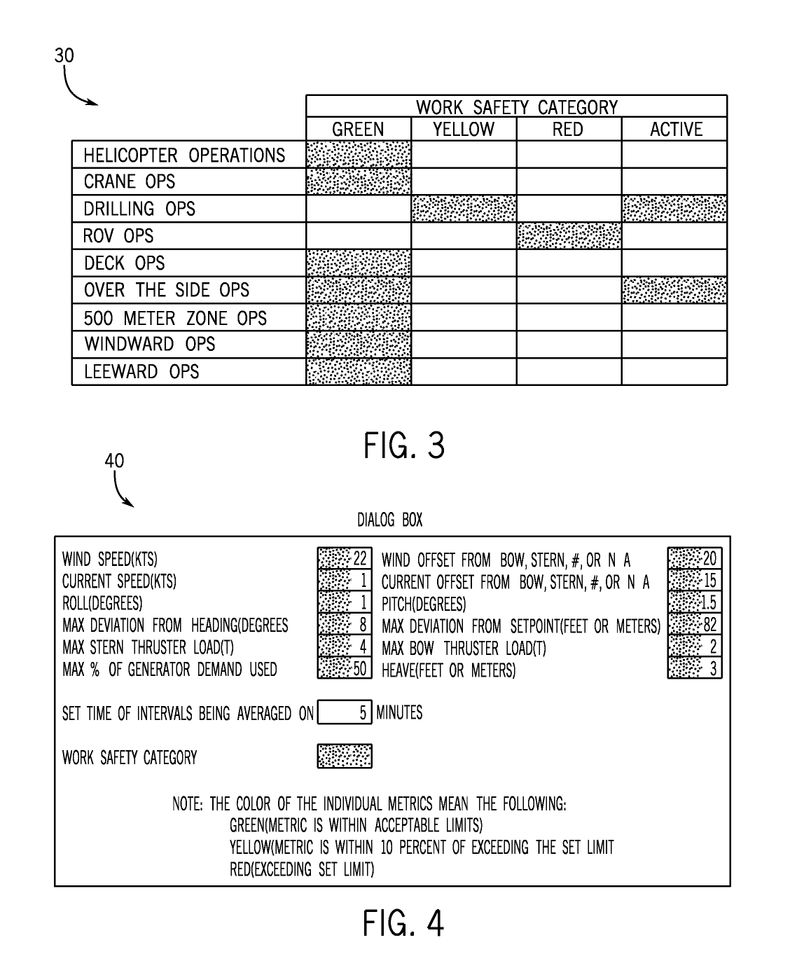

As illustrated in FIGS. 3 and 4, the data may be displayed in a chart 30, which may include multiple warning levels. The multiple warning levels may include green (a safe level), yellow (a warning level) and red (a danger level). Red levels may indicate that the operators should stop working. The data may further be displayed by particular measurements 40. For example, the specific wind speed and current speed may be displayed to a user. The present invention may indicate whether a helicopter may land on the vessel, and whether the operations including crane, deck, or over the side operations may be performed. If the operations are indicated as active and the safety category changes, an audible and visual alarm may go off and may be printed on the alarm printer.

The computer-based data processing system and method described above is for purposes of example only, and may be implemented in any type of computer system or programming or processing environment, or in a computer program, alone or in conjunction with hardware. The present invention may also be implemented in software stored on a computer-readable medium and executed as a computer program on a general purpose or special purpose computer. For clarity, only those aspects of the system germane to the invention are described, and product details well known in the art are omitted. For the same reason, the computer hardware is not described in further detail. It should thus be understood that the invention is not limited to any specific computer language, program, or computer. It is further contemplated that the present invention may be run on a stand-alone computer system, or may be run from a server computer system that can be accessed by a plurality of client computer systems interconnected over an intranet network, or that is accessible to clients over the Internet. In addition, many embodiments of the present invention have application to a wide range of industries. To the extent the present application discloses a system, the method implemented by that system, as well as software stored on a computer-readable medium and executed as a computer program to perform the method on a general purpose or special purpose computer, are within the scope of the present invention. Further, to the extent the present application discloses a method, a system of apparatuses configured to implement the method are within the scope of the present invention.

It should be understood, of course, that the foregoing relates to exemplary embodiments of the invention and that modifications may be made without departing from the spirit and scope of the invention as set forth in the following claims.

What is claimed is:

1. A system for alerting seaman of dangerous conditions, comprising:
a computer having a user interface; and
a program product comprising machine-readable program code for causing, when executed, the computer to perform the following process steps:
receiving inputs from a plurality of sensors placed around a boat;
comparing the inputs to a predetermined range of safe and dangerous conditions; and
displaying a warning signal when the inputs fall within the predetermined dangerous conditions.
